(19) United States
(12) Patent Application Publication
(10) Pub. No.: US 2004/0154122 A1
(43) Pub. Date: Aug. 12, 2004

(54) Vacuum cleaner system for a motor vehicle

(76) Inventor: Weier Xu, Suzhou (CN)

Correspondence Address: PROCOPIO, CORY, HARGREAVES & SAVITCH LLP, 530 B STREET, SUITE 2100, SAN DIEGO, CA, 92101, US

(21) Appl. No.: 10/749,315

(22) Filed: Dec. 31, 2003

(30) Foreign Application Priority Data
Jan. 3, 2003 (CN) 03219171.5

(51) Int. Cl. B60S 1/64

(52) U.S. Cl. 15/313

(57) ABSTRACT

A vacuum cleaner system for the motor vehicle is provided, which comprises a negative pressure generator adapted to be connected with a motive power output of the motor to create a suction source and a dust collection chamber having a dust collection hose and in fluid communication with the negative pressure generator to enable the selective collection of dust in the dust collection chamber or the evacuation of water and other fluid. The invention incorporates a suction impeller and ratio gears, which are adapted to be coupled to the engine of the motor vehicle thus providing sustainable power and energy to the vacuuming cleaning tasks.

### RELATED APPLICATION

The present application claims priority to Chinese Patent Application No. 03219171.5, filed Jan. 3, 2003.

### FIELD OF INVENTION

The present invention relates to a vacuum cleaner, and more particularly to a vacuum cleaning system for a motor vehicle.

### BACKGROUND

In the prior arts, there are vacuum cleaners for motor vehicles that are generally powered by the battery of the vehicle. Such prior art vacuum cleaners exhibit common drawbacks such as lower voltage and low efficiency, which result in little suction power. With extended use, power drain of the battery can occur making the motor of the vehicle quite difficult to start. There are other prior art vacuum cleaners with self-contained batteries as the power source. However, such vacuum cleaners generally lack sufficient dust storage and vacuum power.

### SUMMARY OF THE INVENTION

The present invention provides a vacuum cleaner system for a motor vehicle, which comprises a negative pressure generator adapted to be connected with a motive power output of the motor to create a suction source and a dust collection chamber having a dust collection hose and in fluid communication with the negative pressure generator. The invention further comprises a three way valve to enable the selective collection of dust in the dust collection chamber or the evacuation of water and other fluid, which bypasses of the dust collection chamber. The invention has a suction impeller and ratio gears, which are adapted to be coupled to the engine of the motor vehicle thus providing sustainable power and energy to the vacuum cleaning work.

### BRIEF DESCRIPTION OF THE DRAWINGS

FIG. 1 shows a schematic perspective view of the present invention;

FIG. 2 shows a schematic sectional view of the negative pressure producing or air suction device of the present invention;

FIG. 3 shows a partially enlarged sectional view of A in FIG. 1 with a three-way valve in a first operation position;

FIG. 4 shows a partially enlarged sectional view of A in FIG. 1 with a three-way valve in a second operation position;

FIG. 5 shows a side sectional view of the dust full indicator;

FIG. 6 shows a detailed sectional view of a telescopic water suction hose, hose housing and the three-way valve;

FIG. 7 shows a sectional view of the dust collection chamber, the telescopic dust collection hose and the dust collection hose housing; and

FIG. 8 shows a structural section view of the water suction brush.

### DETAILED DESCRIPTION

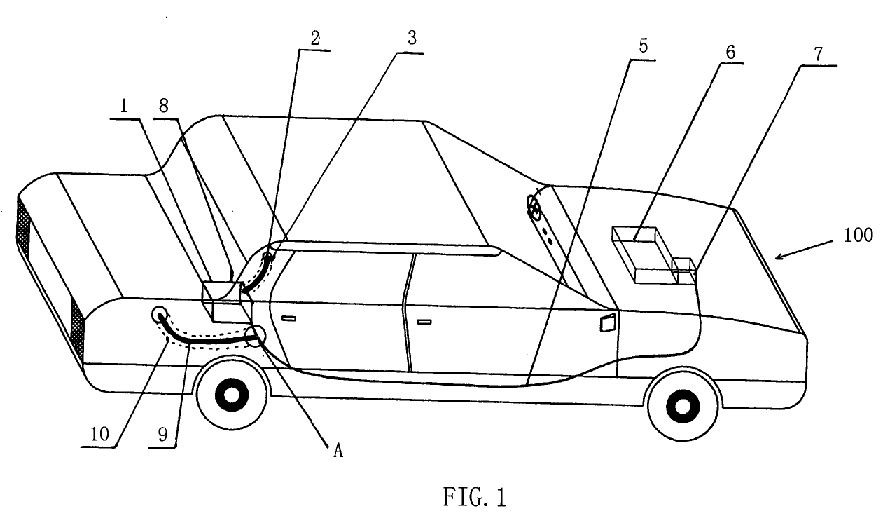

As shown in FIG. 1, a vacuum cleaner system for a motor vehicle is provided. The system comprises a negative pressure generator or a suction source 7, which is adapted to be coupled with the motive power output portion of the motor vehicle 100 to create a suction source.

The present invention has a dust collection chamber 1, which is spaced away from the negative pressure generator 7. A dust evacuation tube 3 forms the entrance to the dust collection chamber, and an exhaust pipe 23 connects the dust collection chamber 1 with the suction source 7 via a connecting pipe 5.

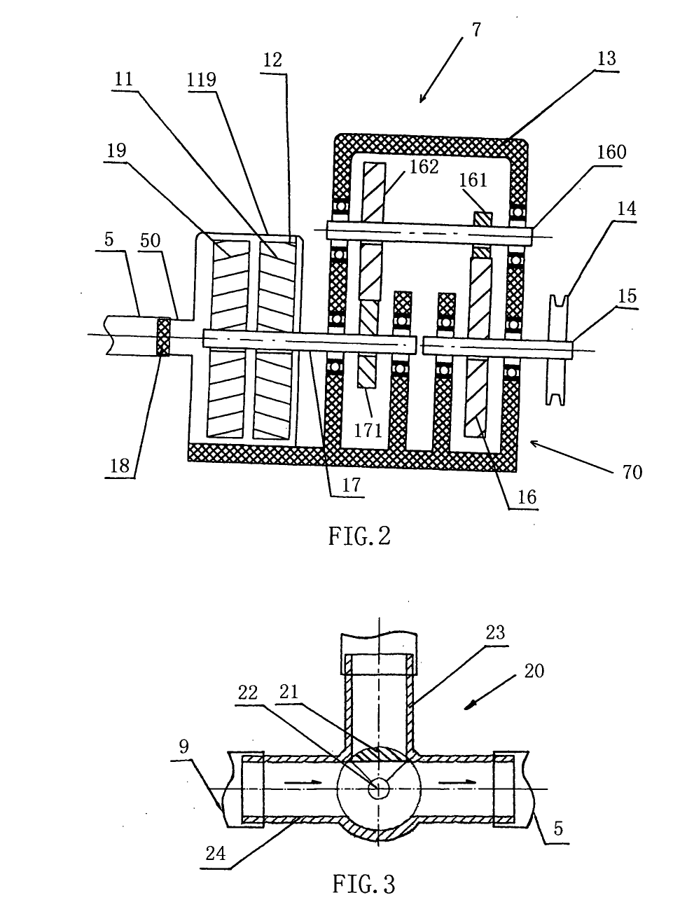

As shown in FIG. 2, a impeller shaft 17 is provided in the negative pressure generator 7, which is connected to the motive power output potion of an engine 6 of the motor vehicle 100 by appropriate power transmission means or ratio gears 16 contained in gear box 13. Connection between the ratio gears with the motive power output portion of the motor vehicle engine can be effected by means of frictional connection, belt transmission or by gear transmission.

As shown in FIG. 2, the negative pressure generator 7 has a moving impeller 19 affixed on impeller shaft 17. As impeller 19 is rotated on the impeller shaft 17 driven by the motive power output of the engine 6, it generates a negative pressure, which in turn draws fluid flow from the dust collection chamber 1 via connecting pipe 5.

Located within connecting pipe 5 is upstream of the negative pressure generator 7 is a filter element 18, to prevent large debris from entering the pressure generator. The filter element 18 can be in the form of a filter net.

As also is shown in FIG. 2, a stationary flow deflector 11 is provided adjacent to the moving impeller 19. The flow deflector 11 directs the fluid flow from the moving impeller 19 to the external environment by way of a flow exit 12.

In the embodiment of the present invention, the ratio gears 16 comprise a speedup gear group for transmitting the motive power of the belt pulley 14. The individual gears in this gear group is designed to enable to the impeller 19 to rotate at high speed. The belt pulley 14 connects to another belt pulley (not shown) provided on the engine 6 of the motor vehicle via a belt (also not shown) for the transmission of the motive power of the motor vehicle.

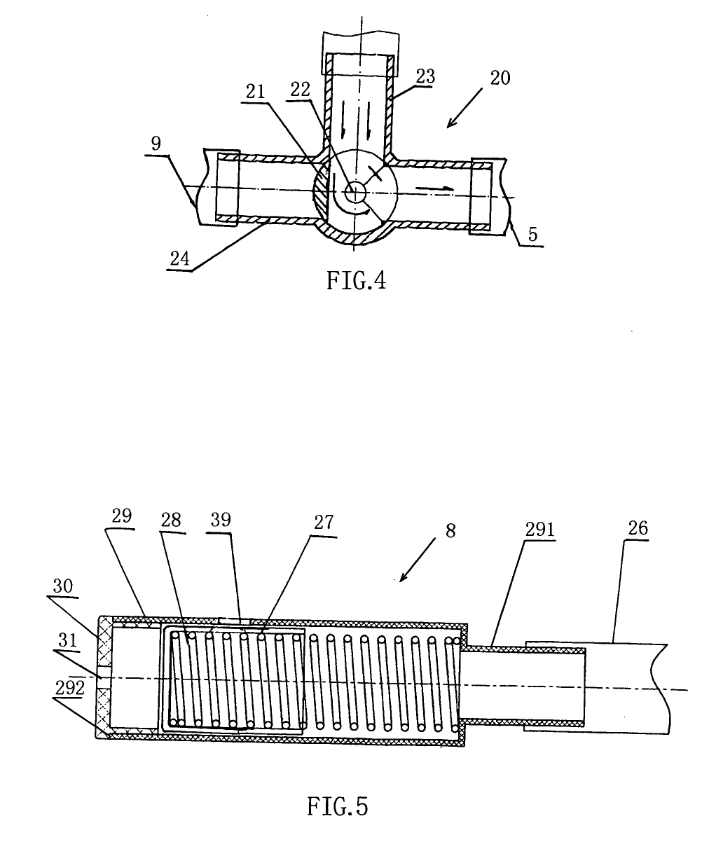

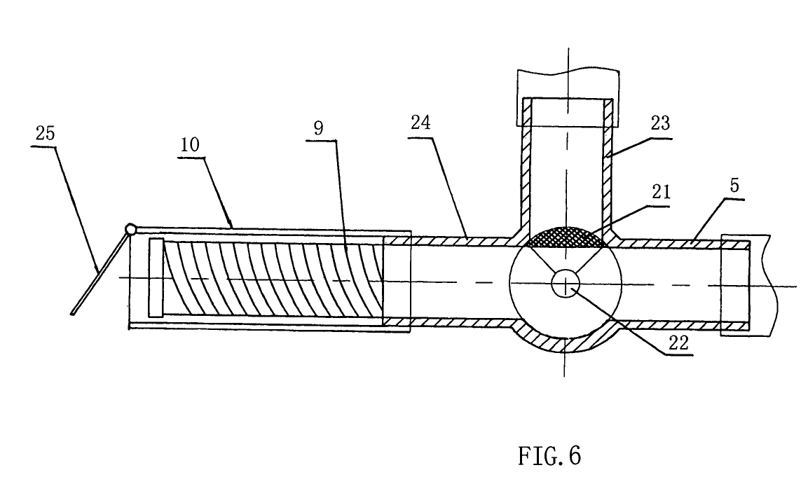

Referring to FIG. 1, FIG. 3, FIG. 4 and FIG. 6, the present invention further comprises a three-way valve 20 disposed between the dust collection chamber 1 and the negative pressure generator 7. and a water suction pipe 24. The three-way valve 20 is connected to the exhaust pipe 23 of the dust collection chamber 1, connecting pipe 5 to the negative pressure generator 1, and a water suction pipe 24. The three-way valve 20 has at least two operating positions. As shown in FIG. 3, under a first operation position, a valve core 21 of the three-way valve 20 blocks exhaust pipe 23 which leads to the dust collection chamber 1. In this operating position, the water suction pipe 24 communicates with the connecting pipe 5 via the three-way valve 20 to enable evacuation of fluid flow such as water during cleaning of the surface of the motor vehicle. In this operating position, the water evacuated in suction pipe 24 enters the negative pressure generator 7 through the connecting pipe 5 and discharges to the exterior of the negative pressure generator 1.

In a second operation position, the valve core 21 of the three-way valve 20 is turned, which blocks the water suction pipe 24 and effects fluid communication between the connecting pipe 5 (and the negative pressure generator 1) and the dust collection chamber by way of the dust exhaust pipe 23. In this operating position, dust collection can be accomplished by way of a telescopic dust collection hose 2. Thus, by changing the position of the three-way valve 20, the dust collection operation or the water suction operation of the present invention can be selected.

Referring to FIG. 6, the water suction pipe 24 is coupled in fluid communication with a telescopic water suction hose 9, which is substantially housed in a tubular casing 10. The telescopic water suction hose 9 can be pulled out from the casing 10 and is of sufficient length to reach the entire exterior surfaces of the motor vehicle for water evacuation. At the end portion of the water suction casing 10, a cover 25 is provided, which pivotally is connected to the lateral side of the water suction casing 10.

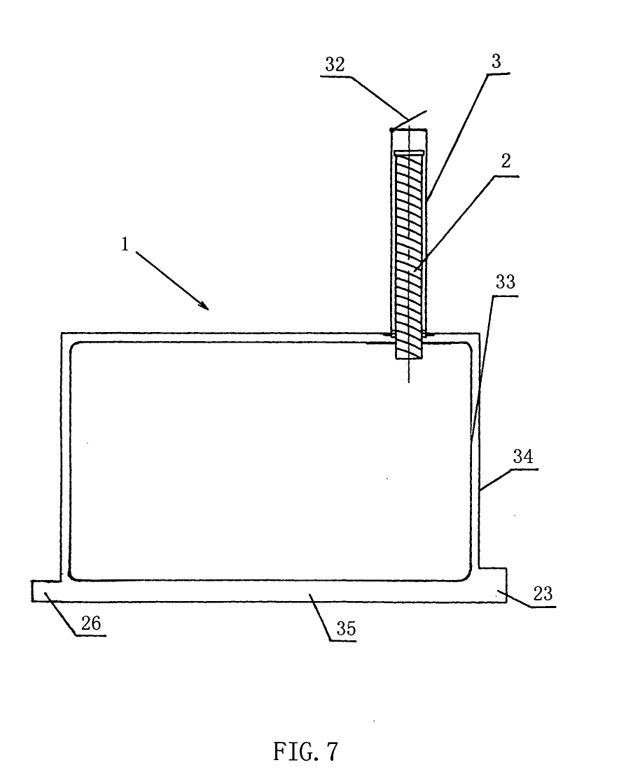

Referring to FIG. 7, the dust collection hose 2 is of telescopic construction and is housed in a dust evacuation tube 3. In use, the telescopic dust collection hose 2 can be pulled outside of the dust collection tube 3. A cover 32 is provided at the end opening pivotally connected to the lateral side of the dust evacuation tube 3.

In the embodiment of the present invention as shown, the dust collection chamber 1 is disposed in a luggage compartment of the motor vehicle.

Referring to FIG. 1, FIG. 5 and FIG. 7, the dust collection chamber 1 is provided with a dust full indicator 8. This dust full indicator 8 includes a tube 29, a plunger 27 slideably provided in the tube 29 and a spring 28 biasing the plunger 27 toward the end portion of tube 29.

Tube 29 is coupled to an inspecting tube 26, which communicates with a negative pressure portion 35 of the dust collection chamber 1. The negative pressure portion 35 is defined by the space between a filter bag 33 disposed in the dust collection chamber 1 and the housing 34 of the dust collection chamber. The other end portion of the annular tube 29 is provided with a stopple 30 with a vent hole 31.

An inspection window 39 is provided on the annular tube 29 to enable observation of position markers (not shown) on the plunger 27. When the filter bag 33 is full or when the filtering efficiency of the filter bag is degraded, the level of the negative pressure section 35 is further increased such that the plunger 27 is able to overcome the biasing force of the spring 28 and move toward inspecting tube 26. This enables an operator to observe the indicating mark on the plunger 27 through the inspection window 39 for further appropriate action such as changing the filter bag 33.

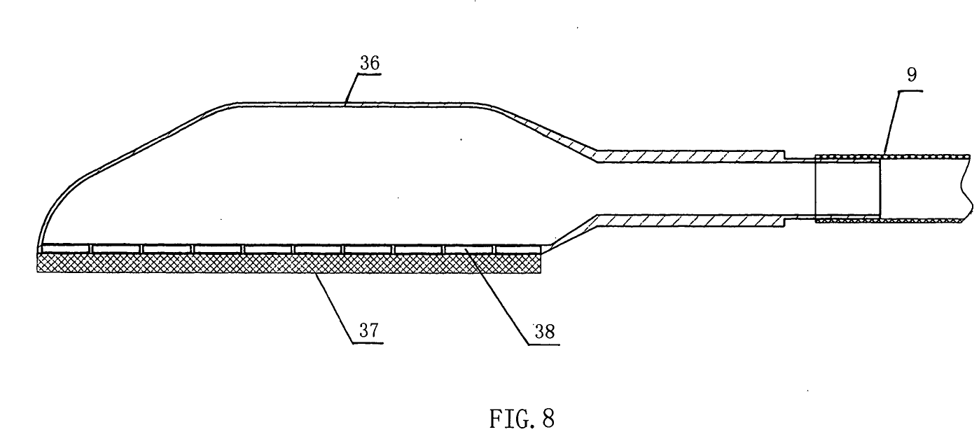

Referring to FIG. 8, an end portion of the telescopic water suction hose 9 is provided with a water suction brush 36 having multiple holes 38 for water evacuation. The water suction brush 36 is also provided with a spongy mass 37 to facilitate cleaning operations.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

I claim:

1. A vacuum cleaner system for the motor vehicle, which comprises:
a negative pressure generator adapted to be connected with a motive power output of the motor vehicle to create a suction source; and
a dust collection chamber having a dust collection hose and in fluid communication with the negative pressure generator to enable selected dust collection in the dust collection chamber.

2. The vacuum cleaner system for the motor vehicle as claimed in claim 1 wherein the negative pressure generator comprises a suction impeller coupled to power transmission means connected to the motive power output of the motor vehicle.

3. The vacuum cleaner system for the motor vehicle as claimed in claim 2 where in the power transmission means are ratio gears coupled to the motive power output potion of the engine of the motor vehicle.

4. The vacuum cleaner system for the motor vehicle as claimed in claim 1, which further comprises a three-way valve for selectively effecting a first operational position to enable the selected dust collection in the dust collection chamber and a second operational position bypassing the dust collection chamber for the evacuation of water by means of the negative pressure generator.

5. The vacuum cleaner system for the motor vehicle as claimed in claim 4, which further comprises a telescopic water suction hose for water evacuation.

6. The vacuum cleaner system for the motor vehicle as claimed in claim 1 wherein the dust collection hose is of telescopic construction.

7. The vacuum cleaner system for the motor vehicle as claimed in claim 1, which further comprises a filter element disposed between the dust collection chamber and the negative pressure generator.

8. The vacuum cleaner system for the motor vehicle as claimed in claim 1 wherein the dust collection chamber is located in a luggage compartment of the motor vehicle.

9. The vacuum cleaner system for the motor vehicle as claimed in claim 5 wherein the telescopic water suction hose is housed in a tubular housing having an end cover.

10. The vacuum cleaner system for the motor vehicle as claimed in claim 6 wherein the dust collection hose is housed in a tubular housing having an end cover.

11. The vacuum cleaner system for the motor vehicle as claimed in claim 1 wherein the dust collection chamber further comprises a dust full indicator having a tubular body, a plunger slideably disposed within the tubular body, and a spring pressing on the plunger, wherein the end portion of the tubular body communicates with a negative pressure portion of the dust collection chamber.

12. The vacuum cleaner system for the motor vehicle as claimed in claim 11 wherein the tubular body has an inspection window.

13. The vacuum cleaner system for the motor vehicle as claimed in claim 5 wherein the telescopic water suction hose is adapted to be coupled to a water suction brush having a plurality of water suction holes in fluid communication with the inner portion of the telescopic water suction, to a spongy mass or to both a water suction brush and a spongy mass.

14. The vacuum cleaner system for the motor vehicle as claimed in claim 1 which further comprises filtering means disposed within the dust collection chamber for dust collection.
